(19) United States
(12) Patent Application Publication
(10) Pub. No.: US 2009/0227337 A1
(43) Pub. Date: Sep. 10, 2009

(54) Gaming System and a Method of Gaming

(76) Inventors: Jamie K. Langille, Las Vegas, NV (US); Patrick A. Finch, Las Vegas, NV (US); Steven D. Rood, Las Vegas, NV (US); Michael A. Shai-Hee, Kingsgrove (AU)

Correspondence Address: MCANDREWS HELD & MALLOY, LTD, 500 WEST MADISON STREET, SUITE 3400, CHICAGO, IL, 60661, US

(21) Appl. No.: 12/252,989

(22) Filed: Oct. 16, 2008

Related U.S. Application Data
(60) Provisional application No. 60/980,701, filed on Oct. 17, 2007.

(51) Int. Cl. A63F 9/24; A63F 13/00

(52) U.S. Cl. 463/20; 463/30

(57) ABSTRACT

A gaming system is disclosed which comprises a symbol selector arranged to select a plurality of symbols from a set of symbols for display at a plurality of display positions in a game display array to define game winning or losing symbol arrangements, and a symbol position modifier arranged to modify the display position of at least one symbol so that the at least one symbol rotates around at least one symbol in the array to define at least one different winning or losing symbol arrangement. The gaming system also comprises an outcome generator arranged to determine a game outcome based on the displayed symbol arrangements and to provide a player reward when the displayed symbols correspond to a winning outcome. A corresponding method of gaming is also disclosed.

### RELATED APPLICATIONS

This application claims priority to U.S. Provisional Patent Application No. 60/980,701, having a filing date of Oct. 17, 2007, which is incorporated herein by reference, in its entirety.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

The present invention relates to a gaming system and to a method of gaming. It is known to provide a gaming system which comprises a game controller arranged to randomly display several symbols from a predetermined set of symbols and to determine a game outcome such as a game win based on the displayed symbols. Such gaming systems may commonly be implemented as a stepper machine provided with reels with each reel carrying several symbols of the set, or a video machine wherein selected symbols are displayed on virtual reels on a graphical display device.

However, while such gaming systems provide users with enjoyment, a need exists for alternative gaming systems in order to maintain or increase player enjoyment.

### BRIEF SUMMARY OF THE INVENTION

In accordance with a first aspect of the present invention, there is provided a gaming system comprising:

a symbol selector arranged to select a plurality of symbols from a set of symbols for display at a plurality of display positions in a game display array to define game winning or losing symbol arrangements;

a symbol position modifier arranged to modify the display position of at least one symbol in the array so that the at least one symbol rotates around at least one central symbol to define at least one different winning or losing symbol arrangement; and

an outcome generator arranged to determine a game outcome based on the displayed symbol arrangements, and to provide a player reward when the displayed symbols correspond to a winning symbol arrangement.

In one embodiment, the symbol position modifier is arranged to modify the display position of at least one symbol when a trigger condition exists. The trigger condition may be a display of at least one trigger symbol, which may be a wild symbol, for example at a particular display position which may be at a display position disposed generally centrally in the array of displayed symbols.

In an alternative embodiment, the trigger condition is the display of a particular combination of trigger symbols such as scattered symbols or a particular combination of adjacently disposed symbols along a line such as three adjacently disposed trigger symbols, which may be wild symbols, disposed along a line generally centrally in the array of the displayed symbols.

The symbol position modifier may be arranged to modify the display position of at least one symbol so that the at least one symbol rotates around a trigger symbol or the combination of trigger symbols or around the center of game display array.

In one embodiment, the symbol position modifier is arranged to repeatedly modify the display position of at least one symbol so that the at least one symbol progressively rotates around at least one symbol, and the outcome generator may be arranged to determine a game outcome based on the displayed symbols after each step of the modification sequence of the display position of at least one symbol.

In one arrangement, the symbol position modifier is arranged to modify the display position of at least one symbol so that the at least one symbol progressively rotates around at least one symbol such as a symbol in the center of the display array by one symbol position with each display position modification. In an alternative embodiment, the symbol position modifier is arranged to modify the display position of at least one symbol so that the at least one symbol rotates around at least one central symbol by more than one symbol position.

In one embodiment, the symbol position modifier is arranged to modify the display position of a plurality of symbols so that the plurality of symbols rotate around the at least one central symbol.

The symbol position modifier may in one embodiment be arranged to modify the display position of at least one symbol so that a plurality of symbols disposed around the at least one central symbol rotate together by a particular angle such as 90□ with each display position modification.

The symbol which is caused to rotate around the at least one central symbol by the symbol position modifier may be disposed immediately adjacent the at least one central symbol.

In one arrangement, the gaming system is arranged so as to modify the orientation of a symbol when the symbol is rotated around the at least one central symbol.

In one arrangement, when the at least one symbol is caused to rotate around the at least one central symbol by the symbol position modifier, at least some display positions disposed adjacent the at least one central symbol do not include a symbol.

The set of symbols may include at least one function symbol having an associated function which may be a wild function, a scatter function, a multiplier function, a repeat win function or a jackpot function.

The gaming system may be implemented as a stand alone gaming machine or across a network.

In accordance with a second aspect of the present invention, there is provided a method of gaming comprising:

selecting a plurality of symbols from a set of symbols for display at a plurality of display positions in a display array to define a game winning or losing symbol arrangement;

modifying the display position of at least one symbol in the array so that the at least one symbol rotates around a symbol at a different display position to define at least one

different winning or losing symbol arrangement; determining a game outcome based on the displayed symbol arrangement and providing a player reward for winning symbol arrangements.

In accordance with a third aspect of the present invention, there is provided a computer program arranged when loaded into a computer to instruct the computer to operate in accordance with a gaming system comprising:

a symbol selector arranged to select and control the display to display a plurality of symbols from a set of symbols at a plurality of display positions in an array and define a winning or losing symbol arrangement;

a symbol position modifier arranged to modify the display position of at least one symbol so that the at least one symbol rotates around a symbol at a different display position to define at least one different winning or losing symbol arrangement; and

an outcome generator arranged to determine a game outcome based on the displayed symbol arrangement and to provide a player reward when the displayed symbol arrangement corresponds to a win outcome.

In accordance with a fourth aspect of the present invention, there is provided a computer readable medium having computer readable program code embodied therein for causing a computer to operate in accordance with a gaming system comprising:

a symbol selector arranged to select and control the display to display a plurality of symbols from a set of symbols at a plurality of display positions in an array and define a winning or losing symbol arrangement;

a symbol position modifier arranged to modify the display position of at least one symbol so that the at least one symbol rotates around a symbol at a different display position to define at least one different winning or losing symbol arrangement; and

an outcome generator arranged to determine a game outcome based on the displayed symbol arrangement and to provide a player reward when the displayed symbol arrangement corresponds to a win outcome.

In accordance with a fifth aspect of the present invention, there is provided a data signal having computer readable program code embodied therein for causing a computer to operate in accordance with a gaming system comprising:

a symbol selector arranged to select and control the display to display a plurality of symbols from a set of symbols at a plurality of display positions in an array and define a winning or losing symbol arrangement;

a symbol position modifier arranged to modify the display position of at least one symbol so that the at least one symbol rotates around a symbol at a different display position to define at least one different winning or losing symbol arrangement; and

an outcome generator arranged to determine a game outcome based on the displayed symbol arrangement and to provide a player reward when the displayed symbol arrangement corresponds to a win outcome.

### BRIEF DESCRIPTION OF SEVERAL VIEWS OF THE DRAWINGS

The present invention will now be described, by way of example only, with reference to the accompanying drawings, in which:

FIG. 1 is a schematic block diagram of components of a gaming system in accordance with an embodiment of the present invention;

FIG. 2 is a schematic block diagram of certain functional components of a gaming system in accordance with an embodiment of the present invention;

FIG. 3 is a diagrammatic representation of a gaming system in accordance with an embodiment of the present invention with the gaming system implemented in the form of a stand alone gaming machine;

FIG. 4 is a schematic block diagram of certain operative components of the gaming machine shown in FIG. 3;

FIG. 5 is a schematic block diagram of certain components of a memory of the gaming machine shown in FIG. 3;

FIG. 6 is a schematic diagram of a gaming system in accordance with an alternative embodiment of the present invention with the gaming system implemented over a network;

FIG. 7 is a flow diagram illustrating game play of a gaming system in accordance with an embodiment of the present invention;

FIGS. 8a to 8d are diagrammatic representations of example displayed symbols of a gaming system in accordance with an embodiment of the present invention during implementation of a game;

FIG. 9 is a diagrammatic representation of example displayed symbols of a gaming system in accordance with an embodiment of the present invention during implementation of a game;

FIGS. 10a to 10h are diagrammatic representations of example displayed symbols of a gaming system in accordance with a further alternative embodiment of the present invention during implementation of a game;

FIGS. 11a and 11b are diagrammatic representations of example displayed symbols of a gaming system in accordance with a further alternative embodiment of the present invention during implementation of a game;

FIG. 12 is a diagrammatic representation of example displayed systems of a gaming system in accordance with a further alternative embodiment of the present invention during implementation of a game; and

FIGS. 13a and 13b are diagrammatic representations of example displayed symbols of a gaming system in accordance with a further alternative embodiment of the present invention during implementation of a game.

### DETAILED DESCRIPTION OF THE INVENTION

Referring to the drawings, there is shown a schematic block diagram of a gaming system 10 arranged to implement a probabilistic game of the type wherein several symbols from a set of symbols are randomly displayed, and a game outcome is determined on the basis of the displayed symbols. With some such probabilistic games, the set of symbols include standard symbols and function symbols, and the game outcome is determined on the basis of the displayed standard symbols and the function associated with any displayed function symbol. For example, standard symbols may resemble fruit such as apples, pears and bananas with a win outcome being determined when a predetermined number of the same fruit appear on a display in the same line, scattered, and so on. The function associated with a function symbol may be for example a wild function wherein display of the function symbol is treated during consideration of the game outcome as any of the standard symbols. A function symbol may be represented as the word “WILD”, a star, or by any other suitable word or symbol. Other functions are also envisaged such as scatter functions, multiplier functions, repeat win functions, jackpot functions and feature commencement functions.

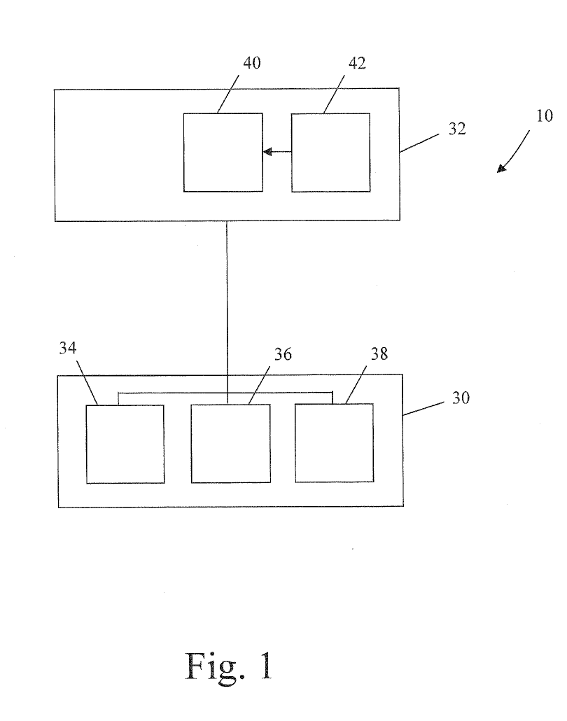

The present gaming system operates such that at least during a portion of a game implemented by the gaming system, the gaming system rotates at least one displayed symbol around one or more other symbols in the array to result in different winning or losing symbol arrangements. For example a symbol may be designated as a trigger symbol and when the trigger symbol appears at a position, the rotation sequence is started. In this way, the player is provided with enhanced enjoyment and an increased likelihood of obtaining a winning outcome. The rotation of one or more symbols in the array may be about a designated central symbol. By “central symbol” is meant a symbol around which at least one other symbol rotates. As such, the central symbol need not be located centrally of the symbol display. Referring to FIG. 1, a schematic diagram of certain components of a gaming system 10 is shown. The components include a player interface 30 and a game controller 32. The player interface 30 is arranged to enable interaction between a player and the gaming system and for this purpose includes input/output components required for the player to enter instructions and play the game.

Components of the player interface 30 may vary but will typically include a credit mechanism 34 to enable a player to input credits and receive payouts, one or more displays 36 which may comprise a touch screen, and a game play mechanism 38 arranged to enable a player to input game playing instructions.

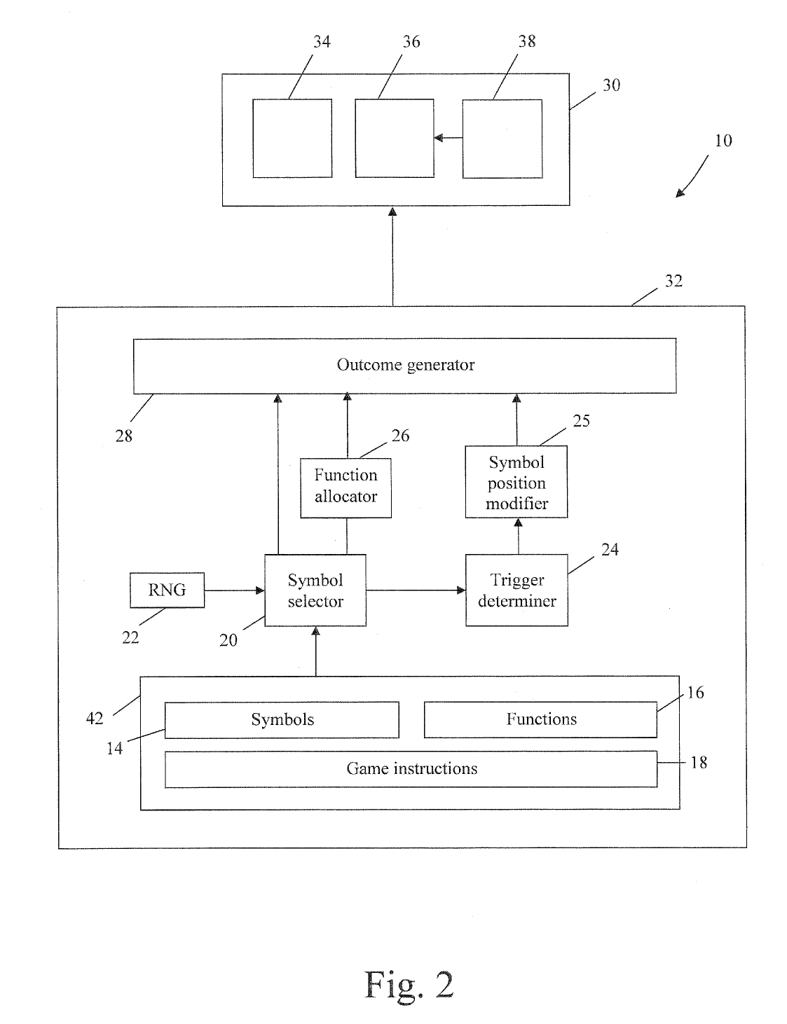

The game controller 32 is in data communication with the player interface 30 and typically includes a processor 40 arranged to process game play instructions and output game player outcomes to the display 36. Typically, the game play instructions are stored as program code in a memory 42 that can also be hardwired. It will be understood that in this specification the term “processor” is used to refer generically to any device that can process game play instructions and may include a microprocessor, microcontroller, programmable logic device or other computational device such as a personal computer or a server. A functional diagram illustrating certain operative components of the game controller 32 is shown in FIG. 2.

The memory 42 is arranged to store symbols data 14 indicative of a plurality of symbols for subsequent display to a player, function data 16 indicative of one or more functions allocatable to the symbols, and game instruction data 18 indicative of game instructions usable by the gaming machine 10 to control operation of the game. The memory 42 may also store data which relates to winning symbol arrangements and the awards therefor.

The game controller 32 includes a symbol selector 20 which is arranged to select several symbols from the selected symbols 14 for display to a player. In this example, the selection carried out by the symbol selector 20 is made using a random number generator 22. It will be appreciated that the random number generator 22 may be of a type which is arranged to generate pseudo random numbers based on a seed number, and that in this specification the term “random” will be understood accordingly to mean truly random or pseudo random.

The game controller 32 also comprises a trigger determiner 24 arranged to determine whether game conditions exist to commence rotation of at least one symbol, and a symbol position modifier 25 arranged to progressively select new display positions to which at least one of the selected symbols is to be moved so as to provide the appearance of at least one symbol which rotates around at least one centrally disposed symbol to define one or more winning or losing symbol arrangements.

In this example, the game controller 32 also comprises a function allocator 26 arranged to select and allocate one or more functions to one or more symbols. Such functions include a wild function, a scatter function, or any other function which may be applied to a symbol or to the game.

The game controller 32 also comprises an outcome generator 28 which in accordance with the game instructions 18 determines winning game outcomes based on the arrangements of symbols selected for display to a player by the symbol selector 20, and, at least for certain arrangements, on the basis of display positions of the symbols after at least one symbol has been rotated around at least one centrally disposed symbol by the symbol position modifier 25. Certain symbol arrangements known as “scatter” wins do not require any particular symbol arrangement pattern in the display array.

In the embodiments described below, the symbol selector 20, the trigger determiner 24, the symbol modifier 25, the function allocator 26, and the outcome generator 28 are at least partly implemented using the processor 40 and associated software and memory, although it will be understood that other implementations are envisaged.

The gaming system 10 can take a number of different forms.

In a first form, a stand alone gaming machine is provided wherein all or most components required for implementing the game are present in a player operable gaming machine.

In a second form, a distributed architecture is provided wherein some of the components required for implementing the game are present in a player operable gaming machine and some of the components required for implementing the game are located remotely relative to the gaming machine. For example, a “thick client” architecture may be used wherein part of the game is executed on a player operable gaming machine and part of the game is executed remotely, such as by a gaming server; or a “thin client” architecture may be used wherein most of the game is executed remotely such as by a gaming server and a player operable gaming machine is used only to display audible and/or visible gaming information to the player and receive gaming inputs from the player.

However, it will be understood that other arrangements are envisaged. For example, an architecture may be provided wherein a gaming machine is networked to a gaming server and the respective functions of the gaming machine and the gaming server are selectively modifiable. For example, the gaming system may operate in stand alone gaming machine mode, “thick client” mode or “thin client” mode depending on the game being played, operating conditions, and so on. Other variations will be apparent to persons skilled in the art.

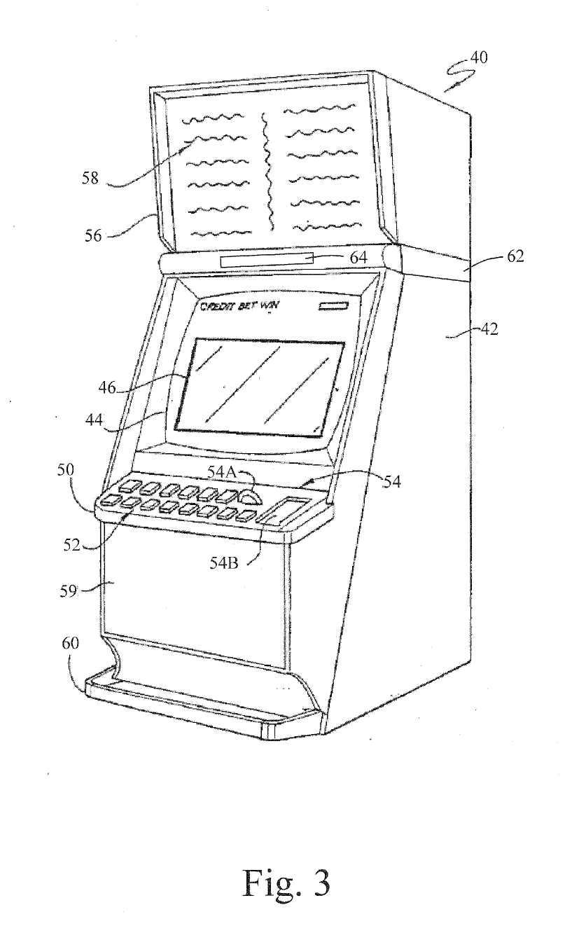

A gaming system in the form of a stand alone gaming machine 40 is illustrated in FIG. 3. The gaming machine 40 includes a console 42 having a display 44 on which is displayed representations of a game 46 that can be played by a player. A mid-trim 50 of the gaming machine 40 houses a bank of buttons 52 for enabling a player to interact with the gaming machine, in particular during gameplay. The mid-trim 50 also houses a credit input mechanism 54 which in this example includes a coin input chute 54A and a bill collector 54B. Other credit input mechanisms may also be employed, for example, a card reader for reading a smart card, debit card or credit card. A reading device may also be provided for the purpose of reading a player tracking device, for example as part of a loyalty program. The player tracking device may be in the form of a card, flash drive or any other portable storage medium capable of being read by the reading device.

A top box 56 may carry artwork 58, including for example pay tables and details of bonus awards and other information or images relating to the game. Further artwork and/or information may be provided on a front panel 59 of the console 42. A coin tray 60 is mounted beneath the front panel 59 for dispensing cash payouts from the gaming machine 30.

The display 44 is in the form of a video display unit, particularly a cathode ray tube screen device. Alternatively, the display 44 may be a liquid crystal display, plasma screen, or any other suitable video display unit and may be embodied as a touch screen display. The top box 56 may also include a display, for example a video display unit, which may be of the same type as the display 44, or of a different type.

The display 44 in this example is arranged to display an array of representations of several reels, each reel of which has several associated symbols. Typically 3, 4 or 5 reels are provided. During operation of the game, the reels first appear to rotate then stop with typically three symbols visible on each reel. Game outcomes are determined on the basis of the visible symbols together with any special functions associated with the symbols, and if a function has been allocated to a reel, on the basis of the allocated function.

A player marketing module (PMM) 62 having a display 64 is connected to the gaming machine 10. The main purpose of the PMM 62 is to allow the player to interact with a player loyalty system. The PMM has a magnetic card reader for the purpose of reading a player tracking device, for example as part of a loyalty program. However other reading devices may be employed and the player tracking device may be in the form of a card, flash drive or any other portable storage medium capable of being read by the reading device.

In this example, the PMM 62 is a Sentinel III device produced by Aristocrat Technologies Pty Ltd.

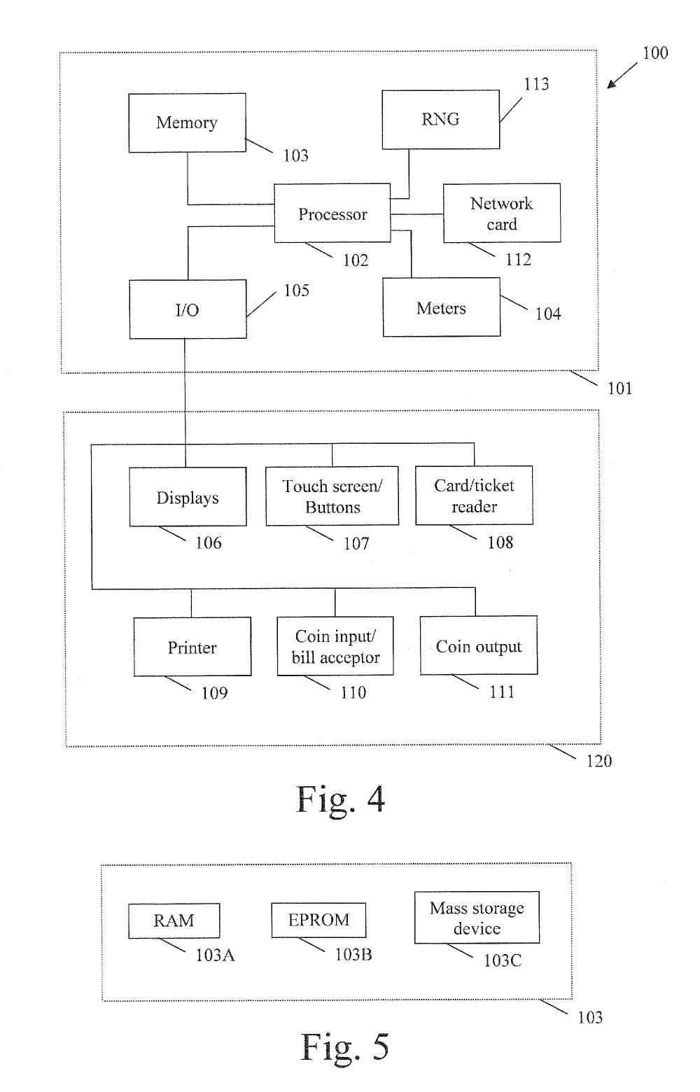

FIG. 4 shows a block diagram of certain operative components of a typical gaming machine 100 which may be the same as or different to the gaming machine shown in FIG. 3.

The gaming machine 100 includes a game controller 101 having a processor 102. Instructions and data to control operation of the processor 102 in accordance with the present invention are stored in a memory 103 which is in data communication with the processor 102.

Typically, the gaming machine 100 will include both volatile and non-volatile memory and more than one of each type of memory, with such memories being collectively represented by the memory 103.

FIG. 5 shows a block diagram of certain components of an exemplary memory 103. The memory 103 includes RAM 103A, EPROM 103B and a mass storage device 103C. The RAM 103A typically temporarily holds program files for execution by the processor 102 and related data. The EPROM 103B may be a boot ROM device and/or may contain some system or game related code. The mass storage device 103C is typically used to store game programs, the integrity of which may be verified and/or authenticated by the processor 102 using protected code from the EPROM 103B or elsewhere.

The gaming machine has hardware meters 104 for purposes including ensuring regulatory compliance and monitoring player credit, an input/output (I/O) interface 105 for communicating with a player interface 120 of the gaming machine 100, the player interface 120 having several peripheral devices. The input/output interface 105 and/or the peripheral devices may be intelligent devices with their own memory for storing associated instructions and data for use with the input/output interface or the peripheral devices. A random number generator module 113 generates random numbers for use by the processor 102.

In the example shown in FIG. 4, the peripheral devices that communicate with the game controller 101 comprise one or more displays 106, a touch screen and/or bank of buttons 107, a card and/or ticket reader 108, a printer 109, a bill acceptor and/or coin input mechanism 110 and a coin output mechanism 111. Additional hardware may be included as part of the gaming machine 100, or hardware may be omitted as required for the specific implementation.

In addition, the gaming machine 100 may include a communications interface, for example a network card 112. The network card may, for example, send status information, accounting information or other information to a central controller, server or database and receive data or commands from the central controller, server or database.

It is also possible for the operative components of the gaming machine 100 to be distributed, for example input/output devices 106,107,108,109,110,111 may be provided remotely from the game controller 101.

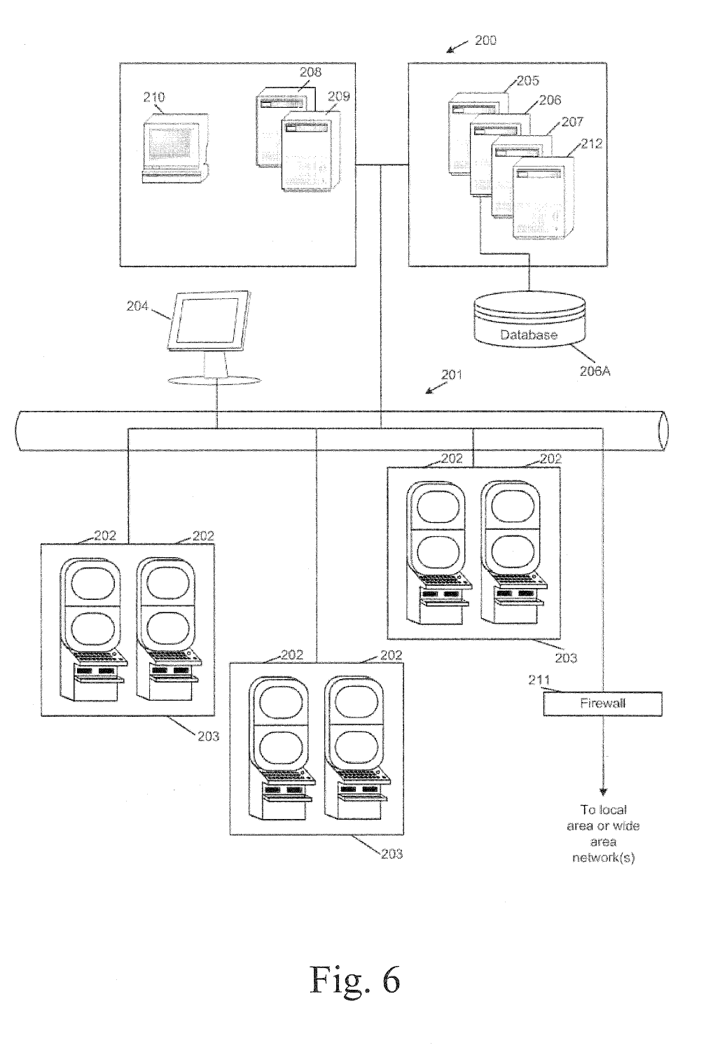

FIG. 6 shows a gaming system 200 in accordance with an alternative embodiment. The gaming system 200 includes a network 201, which for example may be an Ethernet network, a LAN or a WAN. In this example, three banks 203 of two gaming machines 202 are connected to the network 201. The gaming machines 202 provide a player operable interface and may be the same as the gaming machines 40,100 shown in FIGS. 3 and 4, or may have simplified functionality depending on the requirements for implementing game play. While banks 203 of two gaming machines are illustrated in FIG. 6, banks of one, three or more gaming machines are also envisaged.

One or more displays 204 may also be connected to the network 201. The displays 204 may, for example, be associated with one or more banks 203 of gaming machines. The displays 204 may be used to display representations associated with game play on the gaming machines 202, and/or used to display other representations, for example promotional or informational material.

In a thick client embodiment, a game server 205 implements part of the game played by a player using a gaming machine 202 and the gaming machine 202 implements part of the game. With this embodiment, as both the game server 205 and the gaming machine 202 implement part of the game, they collectively provide a game controller. A database management server 206 may manage storage of game programs and associated data for downloading or access by the gaming devices 202 in a database 206A. Typically, if the gaming system enables players to participate in a Jackpot game, a Jackpot server 207 will be provided to monitor and carry out the Jackpot game.

In a variation of the above thick client embodiment, the gaming machine 202 may implement the game, with the game server 205 functioning merely to serve data indicative of a game to the gaming machine 202 for implementation.

With this implementation, a data signal containing a computer program usable by the client terminal to implement the gaming system may be transferred from the game server to the client terminal, for example in response to a request by the client terminal.

In a thin client embodiment, the game server 205 implements most or all of the game played by a player using a gaming machine 202 and the gaming machine 202 essentially provides only the player interface. With this embodiment, the game server 205 provides the game controller. The gaming machine will receive player instructions, and pass the instructions to the game server which will process them and return game play outcomes to the gaming machine for display. In a thin client embodiment, the gaming machines could be computer terminals, e.g. PCs running software that provides a player interface operable using standard computer input and output components.

Servers are also typically provided to assist in the administration of the gaming system 200, including for example a gaming floor management server 208 and a licensing server 209 to monitor the use of licenses relating to particular games. An administrator terminal 210 is provided to allow an administrator to monitor the network 201 and the devices connected to the network.

The gaming system 200 may communicate with other gaming systems, other local networks such as a corporate network, and/or a wide area network such as the Internet, for example through a firewall 211.

A loyalty program server 212 may also be provided.

Persons skilled in the art will appreciate that in accordance with known techniques, functionality at the server side of the network may be distributed over a plurality of different computers. For example, elements may be run as a single “engine” on one server or a separate server may be provided. For example, the game server 205 could run a random number generator engine. Alternatively, a separate random number generator server could be provided.

During operation, the game controller, whether implemented in a stand alone gaming machine 10, 40, 100 or over a network 201, implements a probabilistic game wherein at least during part of the game the gaming system moves the display position of at least one symbol to a new display position so as to provide the appearance of at least one symbol rotating around at least one centrally disposed symbol.

Examples of specific implementations of the gaming system will now be described in relation to a stand alone gaming machine 10, 40, 100 although it will be understood that implementation may also be carried out using other gaming system architectures such as a network architecture of the type shown in FIG. 6.

During normal game mode, reels comprising standard symbols and optionally one or more function symbols are provided. Win outcomes are determined on the basis of the symbol arrangements visible when the reels stop rotating, and in this example three symbols are displayed on each reel at any time. A win outcome may occur based on display of the same symbol along a horizontal or diagonal line, as scattered symbols, or in any other predefined arrangement. A win outcome may also occur on the basis of one or more standard symbols in combination with at least one function symbol having an assigned function. For example a function symbol may correspond to a wild function, a scatter function, a multiply function, a repeat win function, and so on.

During special game mode, at least one symbol is moved in the array so as to provide the appearance that the or each symbol is rotating around at least one centrally disposed symbol, thereby progressively defining one or more new symbol arrangements. Win outcomes may be determined at one or more of the new symbol arrangements. One or a plurality or a group of symbols may be moved.

The or each symbol which is rotated by the symbol position modifier 25 may be disposed immediately adjacent one or more symbols in the array such as a symbol located at or near the center of the display array.

Special game mode may be arranged to commence when one or more trigger symbols appear on the display or may occur entirely randomly. For example, in one embodiment when a particular symbol is selected and displayed anywhere in the array or at a predetermined location, e.g. at the center position in a 3×5 display array representing a five reel game with each reel displaying 3 symbols. In another embodiment, special game mode may be triggered regardless of the symbols selected and displayed. For example, special game mode may be triggered by (i) a separate random selection device which, for example, has numbers 1-100, designates the number “1” as the trigger and with the spin of each game randomly selects a number between 1 and 100 and if “1” is selected, triggers the special mode; or (ii) a trigger issued randomly or as instructed by an operator or as the result of an external event such as a jackpot or the like.

The gaming system may be arranged to commence play of the special game mode when a predetermined game outcome occurs, or may be prompted by a player pressing a button on the gaming system 10, 40, 100 after the player has identified that a game outcome corresponding to special game mode requirements has occurred. For example, special game mode may commence when a specific combination of symbols is displayed such as scattered CAT symbols and at least one displayed symbol subsequently selected as the central symbol(s) around which symbols rotate.

The gaming system 10, 40, 100 may also be arranged so as to determine eligibility for special game mode, for example based on the amount or type of bet placed, based on certain time periods and so on.

Special game mode may also be arranged to commence when a special game feature is purchased by a player.

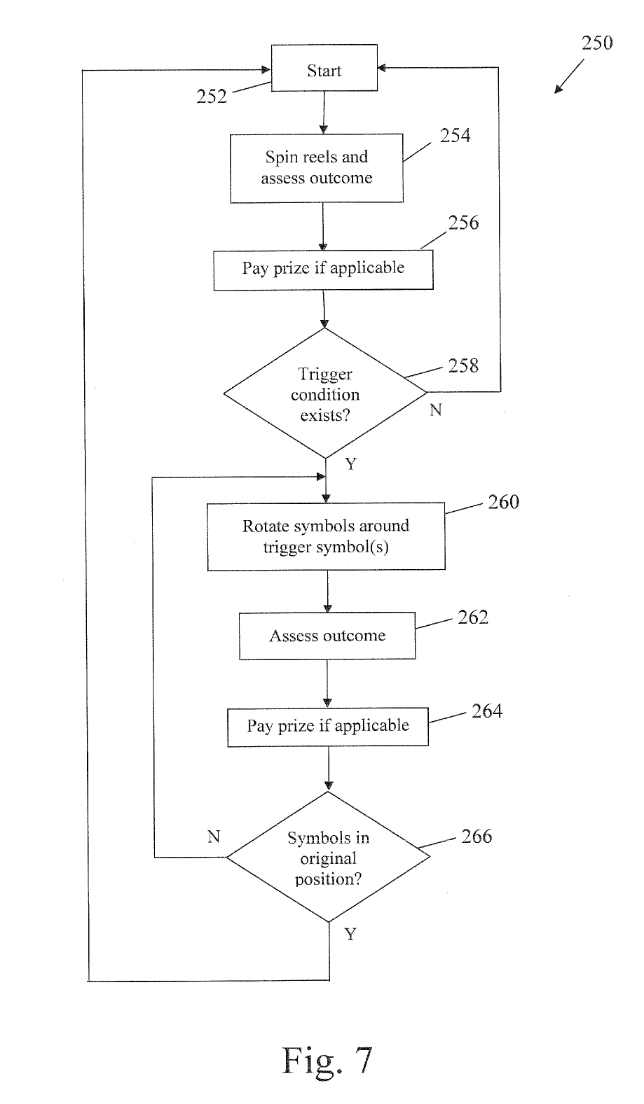

A specific example will now be described in relation to flow diagram 250 shown in FIG. 7 which illustrates steps 252 to 266 of a method of gaming implemented by the gaming system according to the present embodiment.

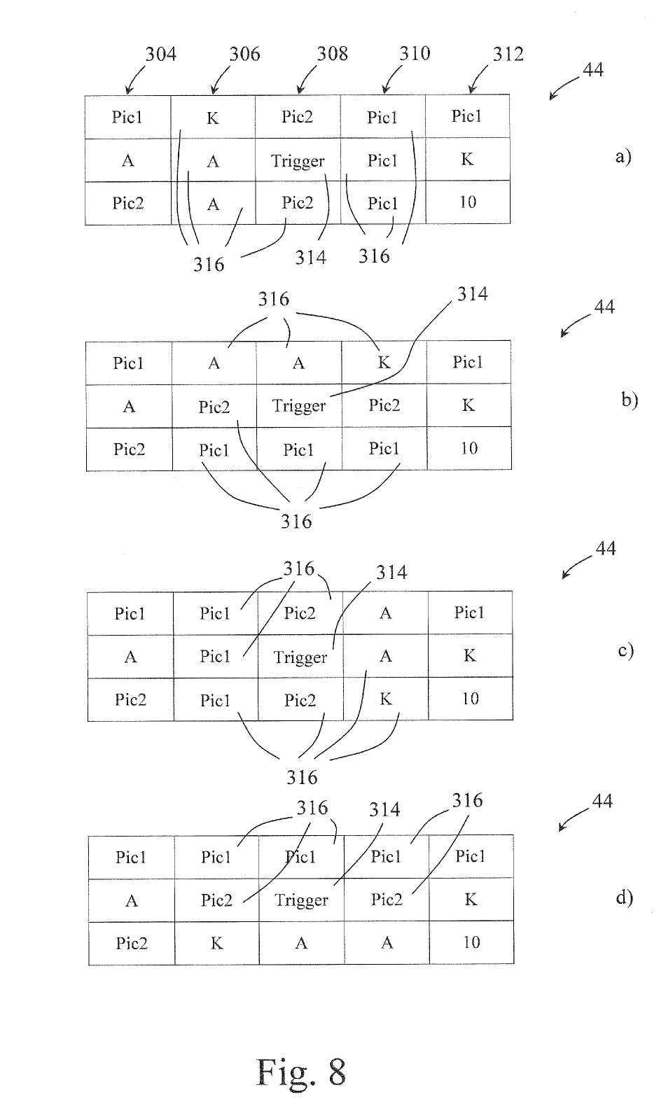

In this example, five reels are provided, with each reel having multiple symbols. The reels are virtual reels and, as such, representations of the reels are displayed on a graphical display device 44. Example representations of the displayed array as shown on the display device 44 are shown in FIGS. 8a to 8d.

During normal game mode, first, second, third, fourth and fifth reels 304, 306, 308, 310 and 312 rotate and the reels stop with three symbols displayed on each reel in the array to define winning or losing symbol arrangements. These arrangements may be along defined and wagered based on pay lines, scattered symbol arrangements or in arrangements as described in U.S. Pat. No. 6,093,102 issued Jul. 25, 2000 and titled “Muliline Gaming Machine”, the disclosure of which is incorporated herein by reference.

The outcome generator 28 evaluates the displayed symbol combination and if the display positions of the symbols correspond to a win outcome a prize is awarded.

When a particular special mode trigger condition occurs during normal game mode or as determined by an external event, for example based on the selection and display of a predetermined trigger symbol 314 in the array, or by a player pressing a button after the player has identified that requirements for special game mode have been met, or in any other way as herein described, the gaming system 10, 40, 100 implements special game mode. Commencement of special game mode may be communicated to a player in any suitable way, for example by displaying an icon on the graphical display.

During special game mode, adjacent displayed symbols 316 rotate together 90° around the trigger symbol 314 one or more positions in a clockwise direction. The original position of the displayed symbols at commencement of special game mode is shown in FIG. 8a and the position of the displayed symbols after the adjacent symbols 316 have been rotated 90° two symbol positions is shown in FIG. 8b.

The outcome generator 28 then evaluates the new displayed symbol arrangement and if the new display positions of the symbols correspond to a winning arrangement a prize is awarded.

The adjacent symbols 316 may then rotate a further 90° two symbol positions in a clockwise direction around the trigger symbol 314 so that the displayed symbols are now disposed in positions shown in FIG. 8c, thereby defining an additional symbol arrangement.

The outcome generator 28 then evaluates the displayed symbol combination and if the displayed positions of the symbols correspond to a win outcome a prize is awarded.

The adjacent symbols 316 then rotate a further 90° two positions in the clockwise direction so that the displayed symbols are disposed in positions shown in FIG. 8d, thereby defining a further different symbol arrangement.

The outcome generator 28 then evaluates the new displayed symbol arrangement and if the display positions of the symbols correspond to a win outcome a prize is awarded. In this example, the display positions shown in FIG. 8d correspond to five Pic1 symbols along a first line which is a win combination and, accordingly, a prize is awarded.

As illustrated, during the rotation sequences the symbols being rotated may be displayed so as to maintain their orientation relative to the display.

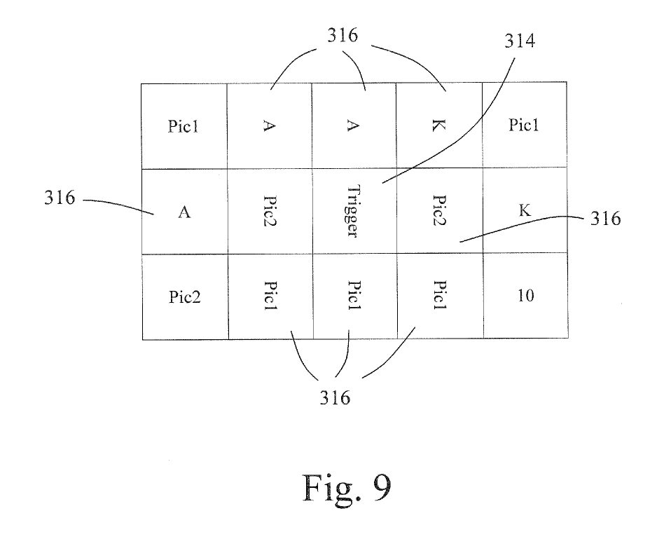

A modified version of this embodiment is shown in FIG. 9. With this variation, rotation of the display positions of the adjacent symbols 316 by 90° in a clockwise direction also causes the orientation of the adjacent symbols 316 to rotate to further highlight to the player that the symbols are rotating.

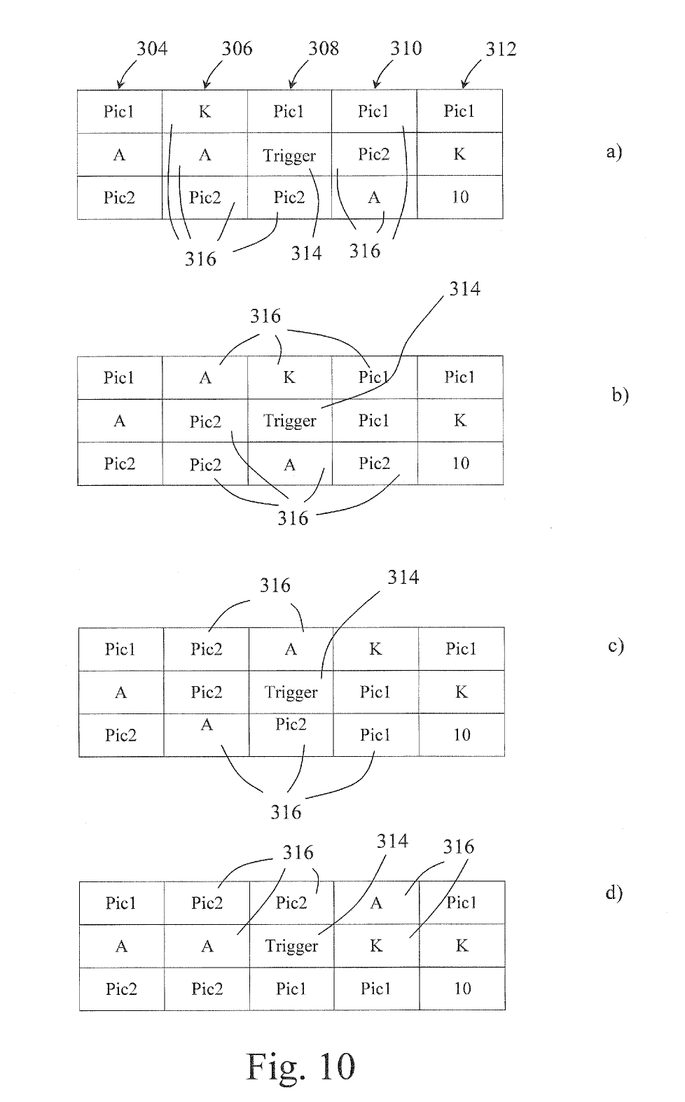

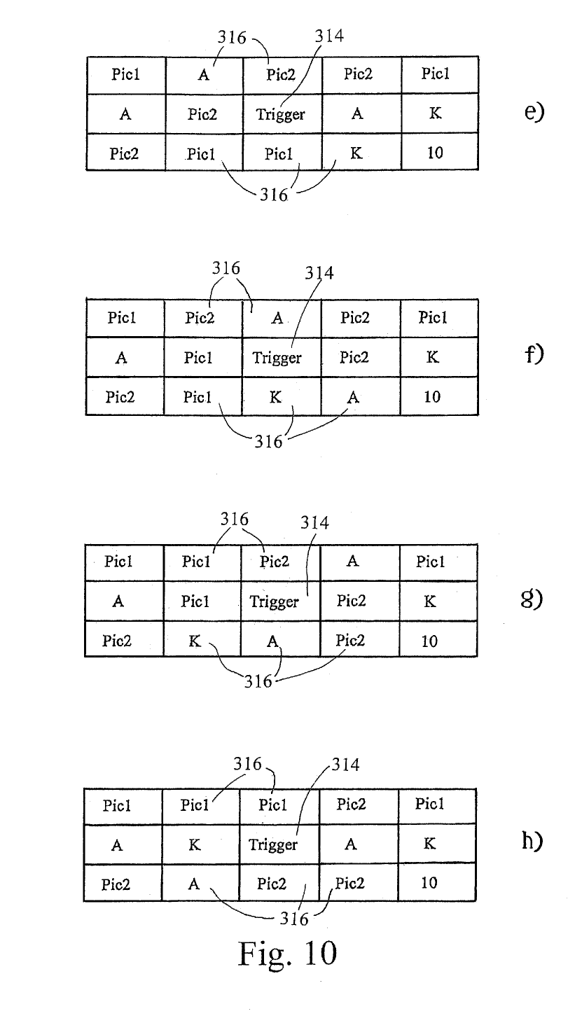

In an alternative embodiment shown in FIGS. 10a to 10h instead of adjacent symbols 316 rotating around a trigger symbol 314 such that the adjacent symbols 316 rotate together 90° clockwise with each individual symbol moving two positions around the trigger symbol 314 with each rotation, with this embodiment with each symbol movement each adjacent symbol 316 moves one position around the trigger symbol 314.

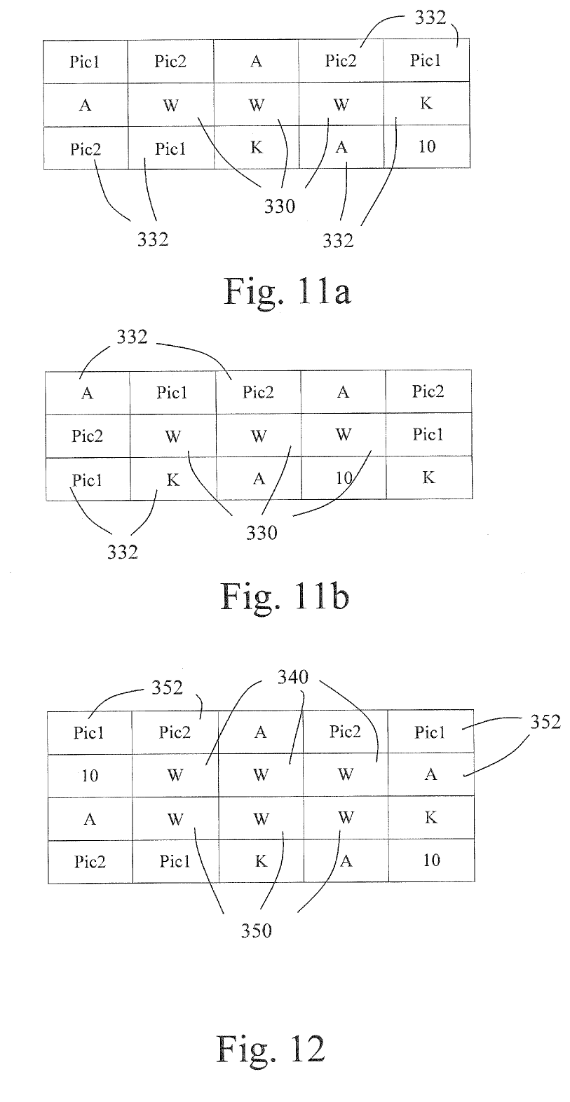

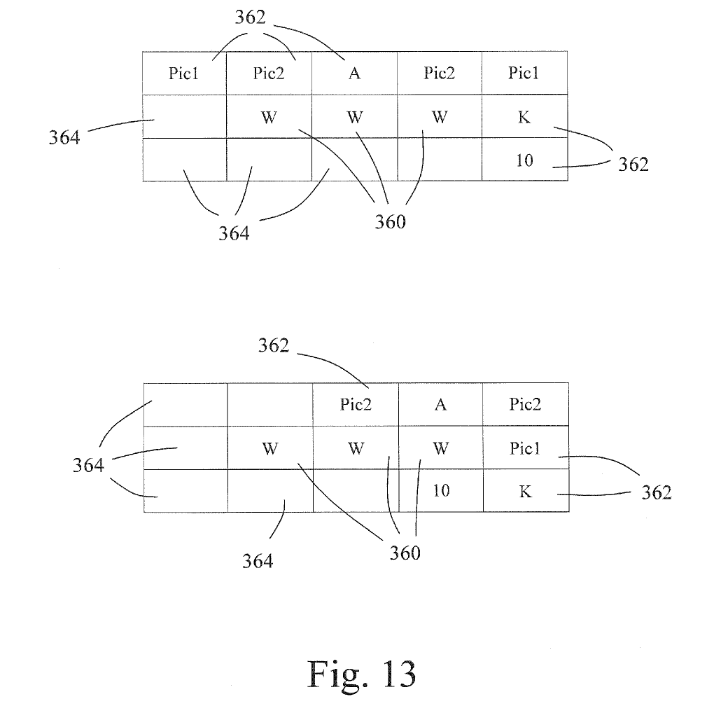

In a further alternative embodiment shown in FIGS. 11a and 11b, instead of commencing special game mode when a trigger symbol appears on the display, special game mode may be caused to commence when a specific combination of symbols appears on the display such as three specific symbols 330 disposed along the middle of a central line of the display. With this embodiment, the three centrally disposed trigger symbols 330 would remain stationary and symbols 332 adjacent the three trigger symbols caused to rotate around the trigger symbols, in this example in a clockwise direction. In this example, the trigger symbols 330 are wild symbols.

In a modification of the embodiment shown in FIGS. 11a and 11b, a display is provided which includes four lines instead of three and special game mode commences when a specific symbol combination appears in the middle of the second and third lines, in this example three specific symbols 340 disposed along the middle of the second line and three specific symbols 350 disposed along the middle of the third line, as shown in FIG. 12. With this embodiment, symbols 352 adjacent the six centrally disposed trigger symbols would rotate around the trigger symbols, for example in a clockwise direction. In this example, the trigger symbols 340, 350 are wild symbols.

In a further modification of the embodiment shown in FIGS. 11a and 11b, a display is provided wherein special game mode commences when a specific symbol combination appears in the middle of the second and third lines, in this example three specific symbols 360 disposed along the middle of the second line. However, with this embodiment, some of the display positions disposed adjacent the trigger symbols 360 include a symbol 362 and some of the display positions 364 do not include a symbol. This provides the appearance of a snake moving around the trigger symbols.

Other variations would include rotating one or more symbols about one or more other symbols at different locations in the display array. For example, if a trigger symbol occurs at any location in the array, adjacent symbols would rotate. If the trigger symbol was at or near a border of the array, rotation may be terminated at the border. Thus a player would hope for the trigger symbol to be at the center to get the most additional symbol arrangements.

Modifications and variations as would be apparent to a skilled addressee are deemed to be within the scope of the present invention.

1. A gaming system comprising:
a symbol selector arranged to select a plurality of symbols from a set of symbols for display at a plurality of display positions in a game display array to define game winning or losing symbol arrangements;
a symbol position modifier arranged to modify the display position of at least one symbol so that the at least one symbol rotates around at least one symbol in the array to define at least one different winning or losing symbol arrangement; and
an outcome generator arranged to determine a game outcome based on the displayed symbol arrangements and to provide a player reward when the displayed symbols correspond to a winning outcome.

2. A gaming system as claimed in claim 1, wherein the symbol position modifier is arranged to modify the display position of at least one symbol when a trigger condition exists.

3. A gaming system as claimed in claim 1, wherein the trigger condition is display of a trigger symbol at a particular display position in the array.

4. A gaming system as claimed in claim 1, wherein the trigger condition comprises display of scattered trigger symbols.

5. A gaming system as claimed in claim 1, wherein the symbol position modifier is arranged to modify the display position of at least one symbol so that the at least one symbol rotates in the array around the at least one trigger symbol to define said different symbol arrangements.

6. A gaming system as claimed in claim 1, wherein the symbol position modifier is arranged to modify the display position of at least one symbol so that the at least one symbol progressively rotates in the array around at least one central symbol to define said different symbol arrangements.

7. A gaming system as claimed in claim 1, wherein the outcome generator is arranged to determine a game outcome based on the displayed symbols after each modification of the display position of at least one symbol to define said different symbol arrangements.

8. A gaming system as claimed in claim 1, wherein the symbol position modifier is arranged to modify the display position of at least one symbol so that the at least one symbol progressively rotates around at least one central symbol by one symbol position with each display position modification.

9. A gaming system as claimed in claim 1, wherein the symbol position modifier is arranged to modify the display position of at least one symbol so that the at least one symbol rotates around at least one central symbol by more than one symbol position with each display position modification.

10. A gaming system as claimed in claim 1, wherein the symbol position modifier is arranged to modify the display position of a plurality of symbols so that the plurality of symbols rotate around the at least one central symbol.

11. A gaming system as claimed in claim 10, wherein the symbol position modifier is arranged to modify the display position of at least one symbol so that a plurality of symbols disposed around the at least one central symbol rotate together by a particular angle.

12. A gaming system as claimed in claim 11, wherein the symbol position modifier is arranged to modify the display position of at least one symbol so that a plurality of symbols disposed around the at least one central symbol rotate together by 90° with each display position modification.

13. A gaming system as claimed in claim 1, wherein each symbol which is caused to rotate around the at least one central symbol by the symbol position modifier is disposed immediately adjacent the at least one central symbol.

14. A gaming system as claimed in claim 1, wherein the gaming system is arranged so as to modify the orientation of a symbol when the symbol is rotated around the at least one central symbol.

15. A gaming system as claimed in claim 1, wherein at least some display positions disposed adjacent the at least one central symbol do not include a symbol when the at least one symbol is caused to rotate around the at least one central symbol by the symbol position modifier.

16. A gaming system as claimed in claim 1, wherein the set of symbols include at least one function symbol having an associated function which may be a wild function, a scatter function, a multiplier function, a repeat win function or a jackpot function.

17. A gaming system as claimed in claim 1, wherein the gaming system is implemented as a stand alone gaming machine.

18. A gaming system as claimed in claim 1, and further including a network.

19. A method of gaming comprising:
providing a display;
selecting and displaying a plurality of symbols from a set of game symbols in a game display array, the positions of said symbols defining a plurality of display positions and a winning or losing symbol arrangement;
modifying the display position of at least one symbol so that the at least one symbol rotates around the display position of at least one other symbol to define at least one different winning or losing symbol arrangement in the array;
determining a game outcome based on the symbol arrangement of the displayed symbols; and
providing a player reward when the displayed symbols corresponds to a winning outcome.

20. A method as claimed in claim 19, comprising modifying the display position of at least one symbol when a trigger condition exists.

21. A method as claimed in claim 20, wherein the trigger condition is display of a trigger symbol at a particular display position in the array.

22. A method as claimed in claim 19, wherein the trigger condition comprises display of scattered trigger symbols.

23. A method as claimed in claim 19, comprising modifying the display position of at least one symbol so that the at least one symbol rotates in the array around the at least one trigger symbol to define said different symbol arrangements.

24. A method as claimed in claim 19, comprising modifying the display position of at least one symbol so that the at least one symbol progressively rotates in the array around at least one central symbol to define said different symbol arrangements.

25. A method as claimed in claim 19, comprising determining a game outcome based on the displayed symbols after each modification of the display position of at least one symbol to define said different symbol arrangements.

26. A method as claimed in claim 19, comprising modifying the display position of at least one symbol so that the at least one symbol progressively rotates around at least one central symbol by one symbol position with each display position modification.

27. A method as claimed in claim 19, comprising modifying the display position of at least one symbol so that the at least one symbol rotates around at least one central symbol by more than one symbol position with each display position modification.

28. A method as claimed in claim 19, comprising modifying the display position of a plurality of symbols so that the plurality of symbols rotate around the at least one central symbol.

29. A method as claimed in claim 28, comprising modifying the display position of at least one symbol so that a plurality of symbols disposed around the at least one central symbol rotate together by a particular angle.

30. A method as claimed in claim 29, comprising modifying the display position of at least one symbol so that a plurality of symbols disposed around the at least one central symbol rotate together by 90° with each display position modification.

31. A method as claimed in claim 19, comprising rotating at least one symbol disposed immediately adjacent the at least one central symbol around at least one central symbol.

32. A method as claimed in claim 19, comprising modifying the orientation of a symbol when the symbol is rotated around the at least one central symbol.

33. A method as claimed in claim 19, wherein at least some display positions disposed adjacent the at least one central symbol do not include a symbol when the at least one symbol is caused to rotate around at least one central symbol.

34. A method as claimed in claim 19, comprising at least one function symbol having an associated function which may be a wild function, a scatter function, a multiplier function, a repeat win function or a jackpot function.

35. A method according to claim 19 and including a computer and a computer program arranged to instruct the computer to operate in accordance with the method.

36. A method according to claim 19 and further including a computer readable medium having the computer program in the form of computer readable code.

37. A method according to claim 19 and further including a data signal having computer readable program code embodied therein.

38. A gaming device comprising:
a video display;
a computer processor; and
a data structure storing data corresponding to game symbols and winning symbol arrangements;
apparatus for a player to prompt play of a game;
said processor configured, when game play is prompted, to (i) select and display game symbols on said display in a game display array to define a winning or losing symbol arrangement, each symbol occupying a position in the array, (ii) detect a trigger condition and in response thereto to control the display to display at least one symbol moving to a plurality of other symbol positions about a designated other symbol so as to define at least one other symbol arrangement and (iii) issue an award for a winning symbol arrangement.
